(19) United States
(12) Patent Application Publication
(10) Pub. No.: US 2026/0251209 A1
(43) Pub. Date: Aug. 27, 2026

(54) FLANGED SPROCKETS AND METHODS OF MAKING

(71) Applicant: GATES CORPORATION, Denver, CO (US)

(72) Inventor: Jing YUAN, Rochester Hills, MI (US)

(73) Assignee: GATES CORPORATION, Denver, CO (US)

(21) Appl. No.: 19/160,199

(22) PCT Filed: Feb. 23, 2024
(86) PCT No.: PCT/US2024/017023

§ 371 Date: Aug. 27, 2025

Related U.S. Application Data
(60) Provisional application No. 63/487,212, filed on Feb. 27, 2023.

(51) Int. Cl. F16H 55/17; B23F 15/00; B23P 15/14

(52) U.S. Cl. CPC F16H 55/171; B23P 15/14; B23F 15/005

(57) ABSTRACT

An internal-flanged sprocket, such as a center-flanged sprocket, for a belt, having an installation-induced stress ring as the flange. The flange is a circular split ring flange having at least one turn and having a first end and an opposite second end. The flange is independent from the sprocket body and is positioned in a groove extending circumferentially around the periphery of the sprocket.

### CROSS-REFERENCE TO RELATED APPLICATIONS

This application claims priority to International Application No. PCT/US2024/017023 filed Feb. 23, 2024 which claims priority to U.S. Provisional Patent Application Ser. No. 63/487,212 filed Feb. 27, 2023, which are incorporated herein in entirety by reference.

### TECHNICAL FIELD

The present application relates to sprockets, sprocket systems, and methods of making the same. More specifically, the present application relates to methods of making sprocket having an internal flange, such as a center flange.

### BACKGROUND

Sprockets can be manufactured using various known methods and technologies. In one example, the sprocket is formed using a die cast method. In such methods, a mold is used to form the specific shape and dimensions of the sprocket, including the tooth profile for the sprocket and any central flange. Die cast processes are economical and capable of forming very precise tooth profiles. In another example, the sprocket is formed by machining. Machining of a sprocket, however, can be time consuming and expensive.

In view of the above, a need exists for new manufacturing methods and configurations for center-flanged sprockets.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The present disclosure is directed to methods of making an internal-flanged sprocket, such as a center-flanged sprocket, for a belt by using an installation-induced stress ring as the center flange. In general, the methods of making include placing a ring into a groove running circumferentially around an outer periphery of a sprocket body; prior to insertion, the ring is a separate element from the sprocket body. The sprocket groove circumference, and diameter, are greater than the ring's circumference and diameter when in a natural state. After installation of the ring in the groove, a sustainable compression stress is developed inside the ring, which prevents any movement and sliding between the ring and the groove. In such a manner, a locking mechanism is achieved due to installation-induced stress, which is achieved by proper sizing and matching the groove and ring dimensions. In some embodiments, the ring may be removed from the groove after installation in the groove, if desired.

In one particular embodiment, this disclosure describes a method of making a sprocket, the method including forming a sprocket body having an outer periphery, creating a groove in the outer periphery of the sprocket body, the groove running circumferentially around the outer periphery, expanding a circular split ring from a natural state to a ply-opening state, positioning the ring over the groove, and releasing the ring into the groove.

Another method of making a sprocket includes providing a sprocket body having an outer periphery with a groove in the outer periphery, expanding a circular split ring from a relaxed state to a stressed state, positioning the ring over the groove, and releasing the ring into the groove.

This disclosure also describes a sprocket having a sprocket body having an outer periphery with a groove extending circumferentially in the outer periphery, and a circular split ring having a first end and an opposite second end, the ring independent from the sprocket body and positioned in the groove. The outer periphery of the sprocket body may have a series of teeth extending therefrom. The groove and resulting flange may be laterally centered in the sprocket body.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a perspective view of a portion of a flanged sprocket having a center flange.

FIG. 2 is a perspective view of a ring prior to installation on a sprocket body.

FIGS. 3A through 3D are perspective views of a step-wise process for installing a ring on a sprocket body to form a flanged sprocket.

FIG. 4 is a side plan view of a flanged sprocket having a center flange.

FIG. 5A is a perspective view of another sprocket having a center flange; FIG. 5B is an enlarged view of the center flange and the sprocket; and FIG. 5C is an enlarged view of the sprocket prior to installation of the ring forming the center flange.

FIG. 6 is a perspective view of another ring prior to installation on a sprocket body.

FIG. 7A is a perspective view of another sprocket, having the ring of FIG. 6; and FIG. 7B is an enlarged view of the flange and the sprocket body.

FIG. 8 is a perspective view of a portion of a flexible belt for use with a center-flanged sprocket.

FIG. 9 is a step-wise flow chart showing steps for forming a center-flanged sprocket.

### DETAILED DESCRIPTION

As indicated above, the present description provides methods of making internally-flanged sprockets (e.g., center-flanged sprockets) for a belt by using an installation-induced stress ring as the flange. The sprocket can be cast, molded, machined, water jet cut, plasma cut, or produced by any process, after which the ring in installed in a groove in the sprocket to form the flange. The groove is formed (e.g., machined) separate from the sprocket and may be formed after creation of the sprocket. The ring is held in the groove by internal stress. The ring may be removable from and replaceable into the groove.

In the following description, reference is made to the accompanying drawing that forms a part hereof and in which is shown by way of illustration at least one specific implementation. The following description provides additional specific implementations. These embodiments are disclosed in sufficient detail to enable those skilled in the art to practice the invention. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

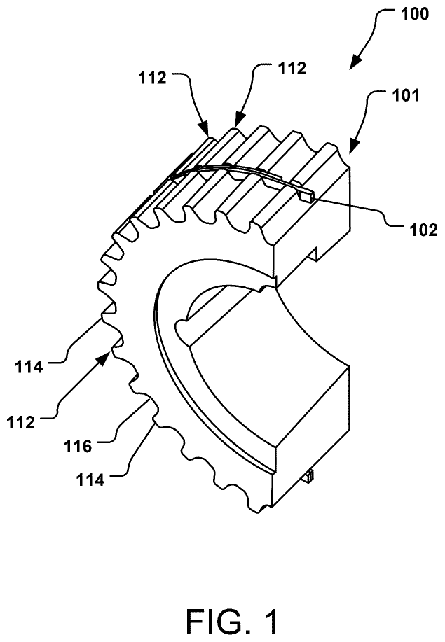

Turning to the figures, a portion of an internally-flanged sprocket 100 is shown in FIG. 1; the flanged sprocket 100 has a sprocket body 101 and a flange 102 centered on the body 101, the flange 102 being an independent and separate and separable element from the body 101. The sprocket body 101 has a generally annular shape, including an inner diameter and an outer diameter and corresponding inner radius and outer radius. The body 101 has a tooth profile, i.e., a series of teeth 112, extending radially outwardly and located around the entire circumference of the body 101. Each tooth 112 has an apex or peak 114, at the outer diameter or radius of the body 101. Adjacent teeth 112 have a valley or land 116 therebetween, at the inner diameter or radius of the body 101.

The flange 102 extends around the outer periphery of the sprocket body 101, in this design, equally centered between the sides of the body 101. In other embodiments, the flange 102 may not be laterally centered in the body 101.

The specific dimensions of the sprocket body 101, including the inner diameter or radius, the outer diameter or radius, which define the circumference, and the side-to-side or lateral width, are generally not limited; nor are the dimensions of the flange 102. Similarly, the specific tooth profile used (including size, shape, spacing and number of teeth) is generally not limited. All of the parameters can be adjusted based on the specific end use application of the sprocket 100. In one example, a sprocket 100 can have a lateral width of the sprocket body 101 of about 10 cm and a width of the flange 102 of about 10 mm (1 cm), with a 32 mm pitch between adjacent teeth 112. In another example, a sprocket can have a lateral width of the sprocket body of about 1 cm and a width of the flange of about 1.2 mm.

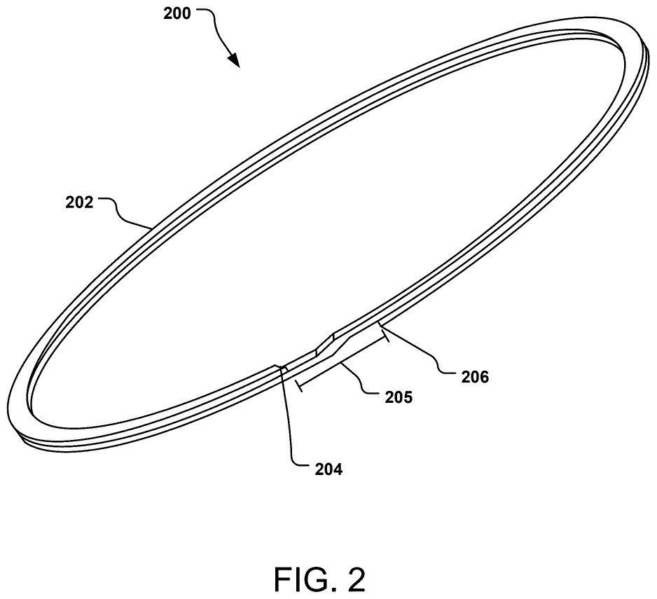

FIG. 2 shows a ring 200, suitable for use as the flange 102 of the sprocket 100 of FIG. 1. The ring 200 is circular split ring; the ring 200 may alternately be referred to as a closed loop, open end ring. The particular ring 200 is tight spiral, such as a keychain ring, having a single metal strip 202 extending less than, but almost, two full turns or rotations, e.g., about 700-710 degrees. Other designs of a ring may have more or less turns or rotations. The metal strip 202 has a first end 204 and a second end 206, with a distance 205 between the ends 204, 206.

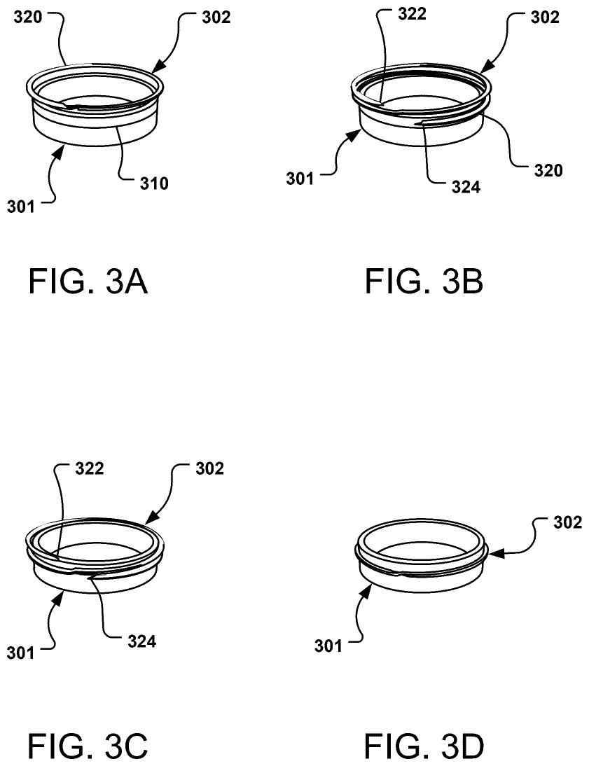

Like a keychain ring, the ring 200 is formed by one open loop steel strip 202. At the end of the first turn of the strip 202, the strip 202 is bent sideway along the axial direction to create an offset to allow the second turn passing through. The two-turns are tightly folded on top of each other to complete a circle while both ends 204, 206 are open. The metal strip 202 can be drawn by a series of progressive dies or a cold/hot roll forming process, and, if beginning with a circular wire, the wire cross section is transformed from circular to oblong. The open ends 204, 206 allow a temporarily diametric size expansion of the ring 200 during the installation of the ring 200 on a sprocket body, as illustrated in FIGS. 3A-3D.

FIGS. 3A through 3D illustrate a separate sprocket body 301 and a ring 302 and, stepwise, a method of applying the ring 302 on the body 301 to form a flanged sprocket. Not seen, the body 301 has a series of teeth extending around the outer periphery. The sprocket body 301 is circular, having a groove 310 formed around the outer periphery through the teeth. The ring 302 is a closed loop, open end ring having almost two turns, such as the ring 200 of FIG. 2, having a strip 320 with a first end 322, a second end 324, and a distance there between.

In FIG. 3A, the ring 302 and the body 301 are separate, with the ring 302 aligned with a side edge of the body 301. In FIG. 3B, the turns of ring 302 are expanded, increasing the circumference and diameter of the ring 302 by increasing the distance 325 between the ends 322, 324 and between the turns of the ring 302. The distance between the multiple turns of the strip 320 is increased to facilitate moving the ring 302 onto the body 301. In FIG. 3C, the ring 302 is shown positioned on the body 301. In FIG. 3D, the ring 302 is shown having been moved on the body 301 and positioned in the groove 310. When seated in the groove 310, the ring 302 may return to the completely unexpanded configuration or may remain partially expanded, depending on the circumference of the groove 310. When the ring 302 remains partially expanded in the groove 310 (meaning, the groove's circumference is slight larger than the flange's inner circumference), the ring 302 remains under pressure, inhibiting potential rattle and noise during use of the sprocket 300.

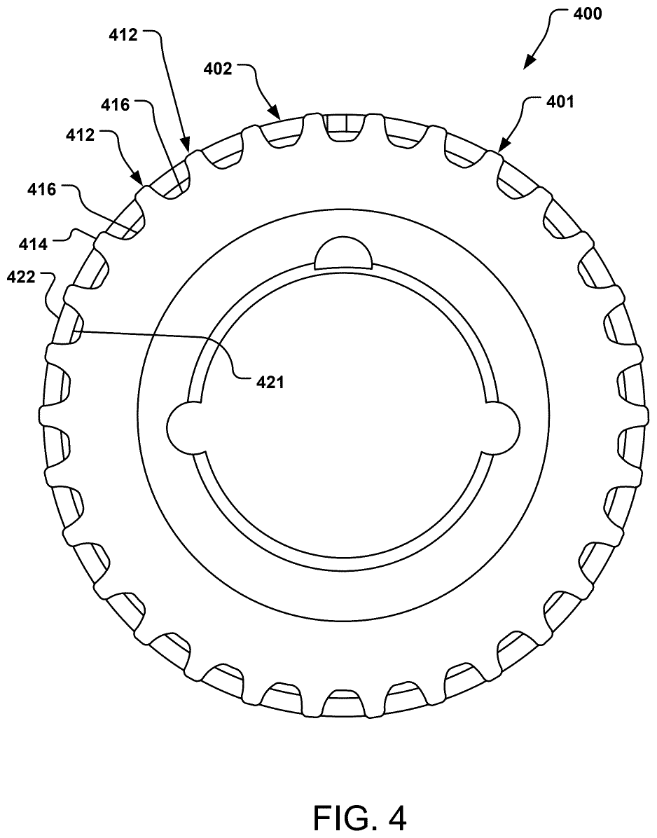

FIG. 4 shows an assembled flanged sprocket 400, having a sprocket body 401 with a series of teeth 412 having an apex or peak 414 and a valley or land 416 between adjacent teeth 412, the teeth 412 extending radially outwardly and located around the entire circumference of the body 401. The sprocket 400 also includes a flange 402 extending around the circumference of the body 401, the flange 402 formed from a ring positioned in a groove (not seen) present in the teeth 412. The flange 402 is an independent and separate and separable element from the sprocket body 401.

In the design of the sprocket 400, with the flange 402 within the groove, the inner circumference 421 of the flange 402 does not rest within or contact the valley or land 416 between the teeth 412, but rather, the flange 402 is raised above the valley or land 416; this is due to the groove in which the flange 402 seats not extending to the valley or land 416. Thus, the inner circumference 421 of the flange 402 is greater than the circumference formed by the valleys or lands 416. The outer circumference 422 of the flange 402 is essentially even with the peak 414 of the teeth 412. Thus, the outer circumference 422 of the flange 402 is essentially the same as the circumference formed by the peaks 414. In other designs, the flange 402 may be slightly above or below the peak 414 of the teeth 412.

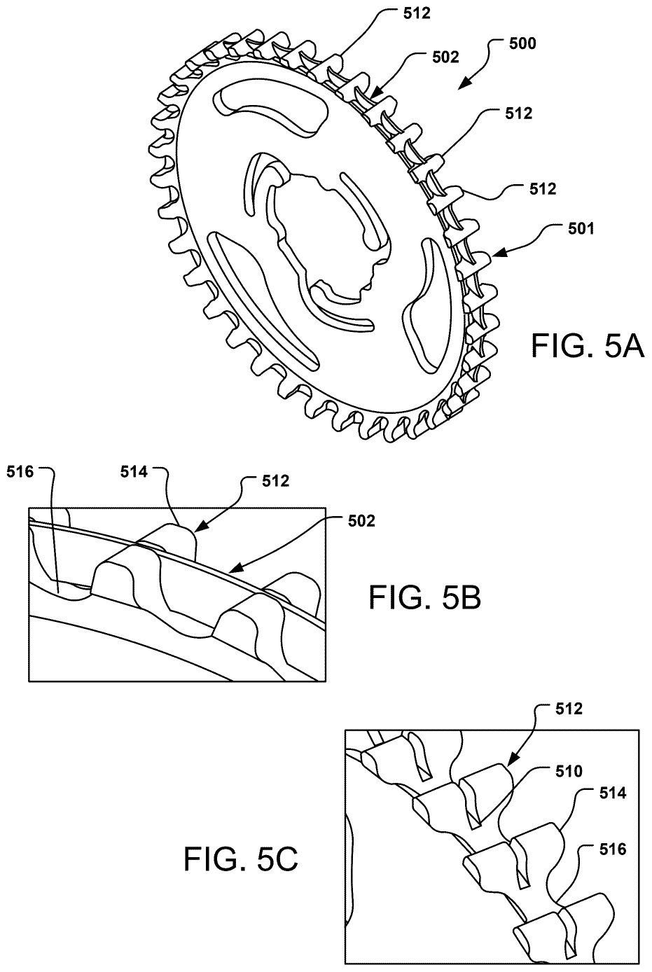

FIGS. 5A and 5B show another assembled center-flanged sprocket 500. Similar to the previous sprockets 100, 400, the sprocket 500 has a sprocket body 501 with a series of teeth 512 around the circumference, the teeth 512 having an apex or peak 514 and a valley or land 516 between adjacent teeth 512. The sprocket 500 also includes a flange 502 extending around the circumference of the body 501, the flange 502 positioned in a groove 510 (seen in FIG. 5C) present in the teeth 512. Again, in this design of the sprocket 500, the inner circumference of the flange 502 does not rest within or contact the valley or land 516 between the teeth 512. Rather, the flange 502 is raised above the valley or land 516, due to the groove 510 not extending to the valley or land 516. The outer circumference of the flange 502 is slightly below the peak of the teeth 512.

FIG. 5C shows a portion of the sprocket body 501 with the flange 502 removed, emphasizing the groove 510.

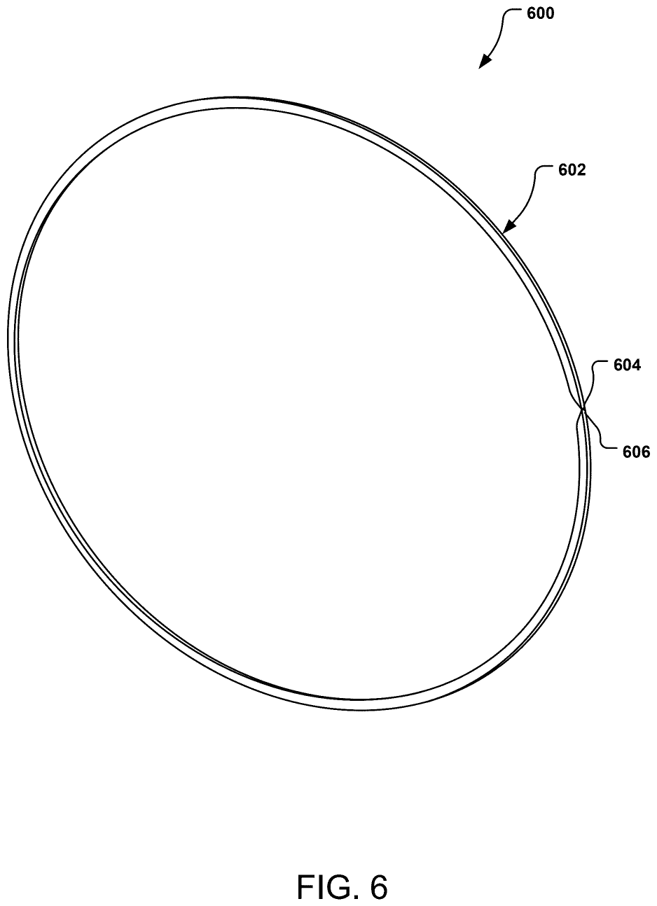

FIG. 6 shows an alternate ring 600 for use as a flange that is circular split ring. The ring 600 may alternately be referred to as a closed loop, open end ring. The particular ring 600 is a single metal strip 602 extending almost one full turn. The metal strip 602 has a first end 604 and a second end 606. The distance between the ends 604, 606 is practically nil; the ends 604, 606 may be in contact with each other. The ends 604, 606 can be separated (e.g., the distance therebetween can be increased) by applying an outward force to the strip 602 to increase the circumference of the ring 600. A single loop or turn, such as the ring 600, has a greater tendency to deform its shape during or after installation than a ring having more than one turn, such as the ring 200 of FIG. 2.

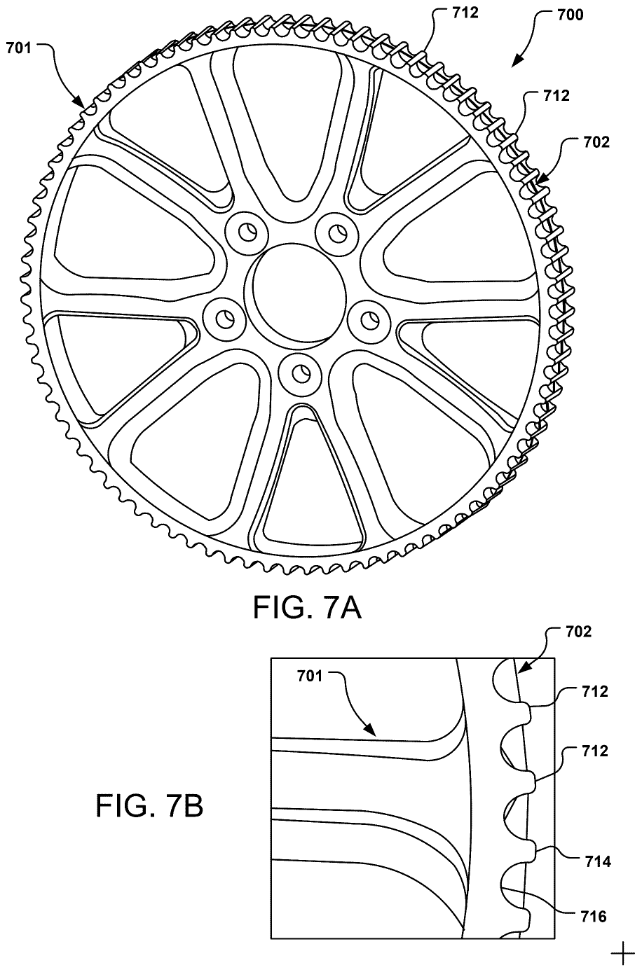

FIG. 7A shows a sprocket 700 and FIG. 7B shows an enlargement of a portion of that sprocket 700. Similar to the previous sprockets 100, 400, 500, the sprocket 700 has a sprocket body 701 with a series of teeth 712 around the circumference, the teeth 712 having an apex or peak 714 and a valley or land 716 between adjacent teeth 712. This sprocket 700 is less wide (from side to side) than the sprockets 100, 400, yet may be a similar width to the sprocket 500.

The sprocket 700 includes a flange 702 extending around the circumference of the body 701, the flange 702 positioned in a groove 710 (not seen) present in the teeth 712. The flange 702 is formed by a ring is similar to the ring 600 of FIG. 6, being a single turn split ring. The outer circumference of the flange 702 is slightly below the peak of the teeth 712, as seen in FIG. 7B. As seen in FIG. 7B, the split between the two ends of the flange 702, in this design, is positioned within the width of a tooth 712.

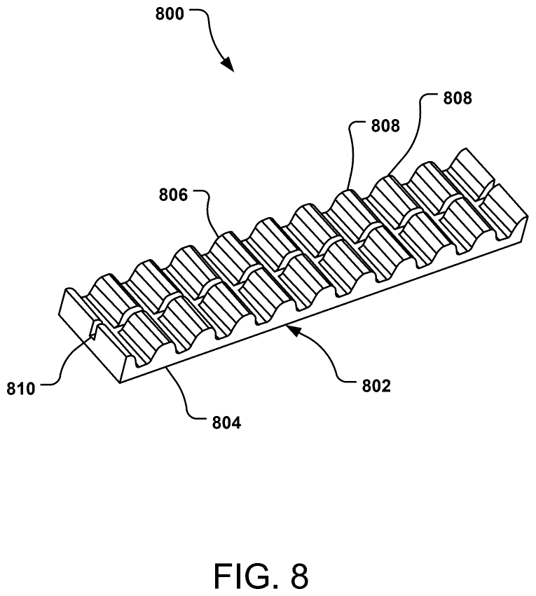

FIG. 8 shows a generic belt 800 that may be used with a toothed sprocket having a center flange, such as the sprocket 100. The belt 800 has a body 802 formed of a flexible material having a back side 804 and a front side 806 with a plurality of teeth 808, the shape of the teeth 808 being compatible with the sprocket with which the belt 800 is intended to be used. Each individual tooth 808 extends perpendicular to the longitudinal length of the belt 800 so that the plurality of teeth 808 run along or around the length of the belt 800. Running through the teeth 808 is a groove 810 compatible with the flange of the sprocket. The groove 810 runs the longitudinal length of the belt 800.

Although not seen in FIG. 8, the belt 800 is an endless belt, having the form of a loop with no beginning and no end. The belt 800 may have a splice therein. The belt 800 may have a plurality of load carrying cords within the body 802. The cords may be, e.g., carbon cords, polymeric cords (e.g., polyester, aramid), fiberglass cords, etc.

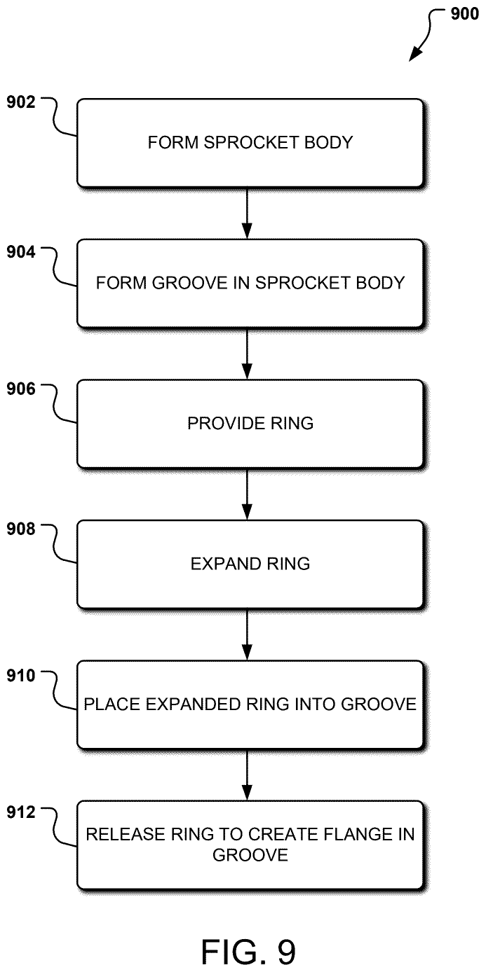

FIG. 9 provides an example method 900 for forming a flanged sprocket, such as described herein. In a first step 902 of the method 900, a sprocket body is formed. The sprocket body is composed of a wheel-type structure with a plurality of teeth extending around the outer circumference of the wheel. The sprocket may be formed by casting, molding, machining, water jet cutting, plasma cutting, or by other suitable process.

In step 904, a groove is formed in the teeth, extending around the circumference in the periphery the sprocket body. The groove may extend the depth of the teeth or may be less than the depth of the teeth. The groove may be formed by machining, water jet cutting, plasma cutting, or by other suitable process. The groove may be centered in the sprocket body or may not be centered.

In step 906, a ring is provided and in step 908 the ring is expanded. The ring is a circular split ring, e.g., a closed loop, open end ring. The ring may have one or more turns, and is expandable from a relaxed, unstressed state to an expanded state.

The choice of the ring with single turn or multiple turns mainly depends on the ring size. Generally speaking, the radial stiffness of the ring is inverse to the diameter or radius of the ring. For a small ring, it is the more difficult to expand the size of the ring; hence, double/multiple turns are beneficial. For a larger ring, it is easier to expand radially; therefore, a single turn is more economical. Another consideration when choosing turns is the ring overall width along the axial dimension. A greater width can be better achieved by multiple turns of thin cross section than a single turn of thick cross section.

The expanded ring is placed onto the sprocket body and into the groove in step 910 and allowed to seat in the groove in step 912 by partially releasing the ring from the expanded state. As the ring remains partially expanded when seated in the groove, the ring and resulting flange remains under pressure, inhibiting potential rattle and noise during use of the resulting sprocket.

From the foregoing, it will be appreciated that specific embodiments of the invention have been described herein for purposes of illustration, but that various modifications may be made without deviating from the scope of the invention. Features or elements from one embodiment may be used or exchanged with features or elements of another embodiment. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately” or “about.” At the very least, and not as an attempt to limit the application of the doctrine of equivalents to the claims, each numerical parameter recited in the specification or claims which is modified by the term “approximately” or “about” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

1. A flanged sprocket comprising:
a sprocket body having an outer periphery with a groove extending circumferentially in the outer periphery; and
a circular split ring flange having a first end and a second end, the flange independent from the sprocket body and positioned in the groove.

2. The flanged sprocket of claim 1, wherein the outer periphery of the sprocket body includes of series of outwardly extending teeth with the groove extending circumferentially through the teeth.

3. The flanged sprocket of claim 2, wherein the first end and the second end of the flange are positioned within a longitudinal width of a tooth.

4. The flanged sprocket of claim 2, wherein the flange has an inner radius greater than an inner radius of the sprocket body defined by the teeth.

5. The flanged sprocket of claim 2, wherein the flange has an outer radius less than an outer radius defined by the teeth.

6. The flanged sprocket of claim 1, wherein the flange is laterally centered in the outer periphery of the sprocket body.

7. The flanged sprocket of claim 1, wherein the flange is a closed loop, open end ring having more than one turn.

8. The flanged sprocket of claim 7, wherein the flange has less than two full turns.

9. The flanged sprocket of claim 7, wherein the flange has an adjustable distance between the first end and the second end.

10. A method of making a flanged sprocket, the method comprising:
providing a sprocket body having an outer periphery with a circumferential groove in the outer periphery;
expanding a circular split ring from a relaxed state to a stressed state;
positioning the ring over the groove; and
releasing the ring into the groove.

11. The method of claim 10, wherein releasing the ring into the groove comprises returning the ring to the relaxed state.

12. The method of claim 10, wherein releasing the ring into the groove comprises the ring having a partially stressed state.

13. The method of claim 10, wherein the ring has a first end and a second end, and expanding the ring comprises increasing a distance between the first end and the second end.

14. The method of claim 10, wherein the ring is a closed loop, open end ring having more than one turn, and expanding the ring comprises increasing a distance between the more than one turn.

15. The method of claim 14, wherein the ring has less than two full turns.

16. The method of claim 10, wherein the outer periphery of the sprocket body includes of series of outwardly extending teeth with the groove extending through the teeth.

17. The method of claim 16, wherein the ring has a first end and a second end, and releasing the ring into the groove comprises positioning the first end and the second end of the flange within a width of a tooth.

18. A method of making a sprocket, the method comprising:
forming a sprocket body having an outer periphery;
creating a groove in the outer periphery of the sprocket body, the groove running circumferentially around the outer periphery;
expanding a circular split ring from a relaxed state to a stressed state;
positioning the over the groove; and
releasing the into the groove to form a flange.

19. The method of claim 18, wherein forming the sprocket body is by casting or molding.

20. The method of claim 18, wherein creating the groove is by machining.
